(19) United States
(12) Patent Application Publication
(10) Pub. No.: US 2010/0219635 A1
(43) Pub. Date: Sep. 2, 2010

(54) INTEGRATED WIND ENERGY HARVESTING SYSTEM AND METHOD

(76) Inventor: Robert W. Evans, JR., Pella, IA (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/713,783

(22) Filed: Feb. 26, 2010

Related U.S. Application Data
(60) Provisional application No. 61/156,176, filed on Feb. 27, 2009.

(51) Int. Cl. F03D 7/00; F03D 9/00

(52) U.S. Cl. 290/44; 290/55

(57) ABSTRACT

A system for generating electricity from wind. The system includes a free-standing structure or some level of building integrated structure comprising at least one inlet, one exit and one APCC ahead of the turbine. At least one turbine is located near the exit end of the APCC. The turbine is adapted to convert wind energy into mechanical energy and the system then converts the mechanical energy into electrical energy and distributes it as designed and needed. At least one dynamically configurable flow control structure is located in the APCC between the air intake and the turbine. One or more dynamically configurable vanes are optionally located near the air inlet to maximize air flow into the APCC. A dynamic flow control system configures the flow control structure in response to air flow conditions to optimize the generation of electrical energy.

### RELATED APPLICATIONS

The present application claims the benefit of U.S. Provisional Application Ser. No. 61/156,176 entitled Wind Energy Generation Integrated into a Building, filed Feb. 27, 2009, the entire disclosure of which is hereby incorporated by reference.

### FIELD OF THE INVENTION

The present invention is directed to wind turbines located in or adjacent to air pre-conditioning chambers (APCC), which may be in stand-alone structures or integrated into building structures, with associated flow control systems that dynamically optimize the wind flowing to the wind turbine to achieve ideal electrical output.

### BACKGROUND OF THE INVENTION

Current commercial wind farms are large scale operations that require vast areas of land in rural areas. Wind turbines can exceed a height of 200 feet, and are typically unsuitable for residential and commercial settings. Wind turbines are commercially viable only in locations with medium to moderately high wind velocities. Wind gusts are a significant issue for current commercial wind harvesting technologies and further restrict useful locations for wind farms. These limitations force wind farms to be located primarily in very narrow regions of the country where the winds are acceptably favorable in annual duration, magnitude and consistency.

A number of factors must properly align to make investment in a wind farm worthwhile, including location, wind dynamics, government incentives, electricity costs, large scale power transmission lines, and turbine costs, to name a few. As a result, smaller-scale commercial wind harvesting in higher density population locations that are rarely used to generate electric power. The concept of energy independent commercial buildings is currently unattainable for the vast majority of cases.

### BRIEF SUMMARY OF THE INVENTION

The present invention is directed to systems and methods for commercial harvesting of wind energy at a building site, using low profile designs and installations with dynamic wind velocity and mass flow optimization technologies disclosed here. The present systems and methods solve the problem of previously unmanageable wind gusts by locating the turbines in or adjacent to relatively large sized tunable air pre-condition chambers (APCC) integrated in stand-alone or building structures.

The APCC design is much more than just an air inlet or a simple wedge to increase wind velocities. The APCC is volumetrically a relatively large space that, by design, uses the principles of air compressibility, substantial air mass, travel distance, vane and wall vectoring, and time, to achieve laminar flow, properly aligned for the turbine, while smoothing out (buffering) air flow to the turbine from counterproductive wind gust related velocity pulses/swings, and does so without negatively impacting average wind energy delivery to the turbine in times of steady winds. This smoothed, laminar and properly aligned wind delivery to the turbine section maximizes turbine stability and durability, while increasing total turbine output by minimizing inertial losses. Further, the APCC walls can be shaped dynamically to real-time optimize wind flow into the turbine, in nearly any variety of wind conditions, and thereby produce significant increases in electrical power over a very wide range of ambient weather conditions much of which are not currently commercially unusable.

The APCC needs certain geometric constraints, in order to be effective in smoothing flow velocity and pressure pulses, developing near laminar flow, and establishing proper flow vectors relative to the turbine. By way of example only, for winds with mean velocities of between about 3 miles per hour (“mph”) to about 70 mph, a highly desirable working range, the distance from the mouth of the APCC to the front face of the turbine working surfaces is preferably between about 1 to about 20 times the width of the turbine exposed face. For a vertical axis turbine, the width of the APCC is preferably between about 1 to about 15 times the width of the turbine exposed face. The height of the APCC is preferably between about 1 to about 5 times the height of the turbine exposed face. The total volume of the APCC therefore is preferably between about 200 to about 300,000 cubic feet for a turbine working face about 10 feet tall and about 2 feet wide. The time for the air to be contained in the APCC is typically between about 1 to about 3 seconds.

Various flow control structures, such as vanes, baffles, bypass ducting, bladders and louvers are used to dynamically control, regulate and tune the wind flow coming through the inlet, through the APCC and into the turbine and finally out the exhaust section. It is especially important that the present systems and methods permit commercial-scale electrical output in locations with low to very high wind velocities and which are not currently suitable for wind harvesting, as well as all the locations with wind conditions between these extremes.

The present systems and methods employing a specialized APCC and dynamic flow control systems also permit commercial wind energy harvesting through a very wide range of severe weather conditions where such commercial activity is often not currently possible. The fast response time of the dynamic control systems allows very short notice automatic shutdowns and restarts. In the case of ice storms, for example, the present systems and turbine output would only be down during the actual falling of the slush and ice whereas; current systems can be down for days. These systems permit the present system to capture and convert a significantly greater percentage of the wind's energy than has ever been practically possible before.

Further, the present invention can be deployed at commercially viable levels over most of the United States, rather than the narrow site bands in which existing technology must be placed. This also means that, with the present systems, a more distributed approach can be taken toward resupplying the electric utility grid. Therefore, new, massive and extremely expensive power transmission lines are largely unnecessary.

The stand-alone or partially integrated building structure(s) in which the turbines are located reduce noise, increase safety, increase turbine life, and maintain aesthetics in residential and commercial settings. The turbine intakes and APCCs can be located at ground level or various heights. Consequently, the present system and method are suitable for use in high density urban areas. In many applications, there will be need for keeping people out of contact with any of the moving parts of the system. These types of devices are known to practitioners of the machinery building and operating arts. Further, given the outdoor nature of the installations, some type of common protection needs to be provided to prevent stray animals from coming into contact with the system. These too are well known to practitioners of the construction and machinery arts. The power generated for a building can be distributed back into the grid, consumed within the building, stored by various devices for later use, or some combination thereof. Power put back into the electrical utility grid can go over existing service lines, thereby greatly reducing installation costs.

The present APCC design and dynamic flow control system greatly reduce the negative effects of wind gusts upon wind based electrical power generation. The present system also reduces the need for complex techniques currently used to protect expensive wind turbines and associated equipment from severe weather while increasing uptime in previously unfavorable wind conditions. Locating the turbines within structures greatly increases safety, security and control. The mechanically simpler and less costly approach of the present systems and methods mean less operating expenses and higher up-time for maximizing productivity.

One embodiment of the present invention is directed to a system for generating electricity from wind. The system includes a structure (all or part of which may be stand-alone or part of a building) comprising at least one air intake, an APCC, a turbine section and an air exhaust outlet along with a complement of sensors, computing systems and control devices. A dynamic flow control system configures the flow control structure in the APPC in response to ambient wind and pre-turbine air flow conditions to optimize the generation of electric energy. The turbine is adapted to convert mechanical energy from the rotation of blades under force of the wind into electrical energy.

Actuators of various types are used to dynamically displace and/or configure the APCC flow control structure in at least one of rotation or translation. At least one dynamically configurable bypass is provided to control potentially excess velocity and volume of wind directed to the turbine. At least one deflector is provided which prevents wind from impacting back sides of the turbine blades, thereby further increasing output efficiency.

The internal shape of the APCC flow control structure is preferably dynamically configurable over a range of shapes including curved surfaces. In one embodiment, dynamically configurable louvers are located near the air intake of the APCC.

The louvers are adapted to substantially direct and scale wind flow into and through the APCC. In another embodiment, dynamically configurable louvers are located near the air exhaust outlet of the turbine section. The louvers can be used to control back pressure on the turbine blades and/or to direct airflow and noise leaving the air outlet.

A plurality of sensors is preferably located in and around the structure, and in and around the APCC and turbine, which measure air flow characteristics of the wind. A computer controls the air flow structures in response to air flow characteristics and turbine operation characteristics to maximize electric energy generation.

The present invention is also directed to a building including at least one APCC having an air intake and an air outlet, and at least one turbine located in proximity to the APCC. The turbine is adapted to convert mechanical energy from the rotation of blades under force of wind into electrical energy. At least one dynamically configurable flow control structure is located in the APCC between the air intake and the turbine. A dynamic flow control system configures the flow control structure in response to air flow conditions to optimize the generation of electric energy.

The present invention is also directed to a dynamic flow control system for generating electricity from wind. The system includes a building having at least one APCC having an air intake and an air outlet. At least one turbine is located in proximity to the APCC. The turbine is adapted to convert mechanical energy from the rotation of blades under force of the wind into electrical energy. At least one dynamically configurable flow control structure is located in the APCC between the air intake and the turbine. A plurality of sensors is located in and around the structure that measure air flow characteristics of the wind and turbine operation characteristics. A computer controls the air flow structures in response to air flow characteristics of the wind and turbine operation characteristics provided by the sensors to optimize electric energy generated.

### BRIEF DESCRIPTION OF THE SEVERAL VIEWS OF THE DRAWING

FIG. 1 is a perspective view of a roof-mounted integrated wind energy harvesting system in accordance with an embodiment of the present invention.

FIG. 2 is a front view of the wind energy harvesting system of FIG. 1.

FIG. 3 is a top perspective view of the wind energy harvesting system of FIG. 1 with a transparent roof for illustration purposes.

FIG. 4 is a side view of the wind energy harvesting system of FIG. 1.

FIG. 5 is a top perspective view of the wind energy harvesting system of FIG. 1 with the roof removed to reveal more details.

FIG. 6 is a front view of a side-mounted partially building integrated wind energy harvesting system in accordance with an embodiment of the present invention.

FIG. 7 is a top perspective view of the wind energy harvesting system of FIG. 6.

FIG. 8 is a top perspective view of the wind energy harvesting system of FIG. 6 with the roof removed to reveal more details.

FIG. 9 is a perspective view of a full or partially building integrated wind energy harvesting system located between two structures in accordance with an embodiment of the present invention.

FIG. 10 is a top perspective view of the wind energy harvesting system of FIG. 9.

FIG. 11 is a top perspective view of the wind energy harvesting system of FIG. 9 with the roof removed to reveal more details.

FIG. 12 is a perspective view of a wind control system for a free standing or partially building integrated wind energy harvesting system in accordance with an embodiment of the present invention (roof removed for viewing).

FIG. 13 is a perspective view of a side-mounted integrated wind energy harvesting system in accordance with an embodiment of the present invention with the top, side wall and ADCC control surfaces removed for viewing.

FIG. 14 is a perspective top view of an alternate wind control system for a free standing or building integrated wind energy harvesting system in accordance with an embodiment of the present invention and with the top removed for viewing.

FIG. 15 is a perspective front view of an alternate wind control system for the wind energy harvesting system of FIG. 14 and in accordance with an embodiment of the present invention.

FIG. 16 is a perspective view of an alternate wind control system, free standing or partially integrated into a building, for an integrated wind energy harvesting system in accordance with an embodiment of the present invention.

### DETAILED DESCRIPTION OF THE INVENTION

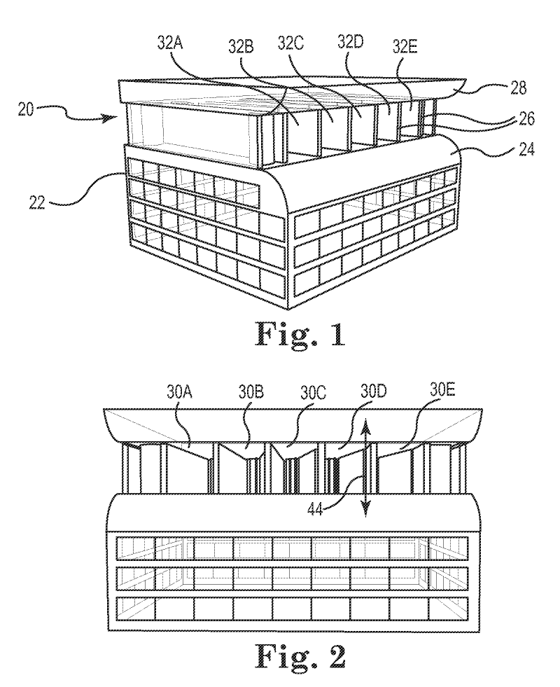

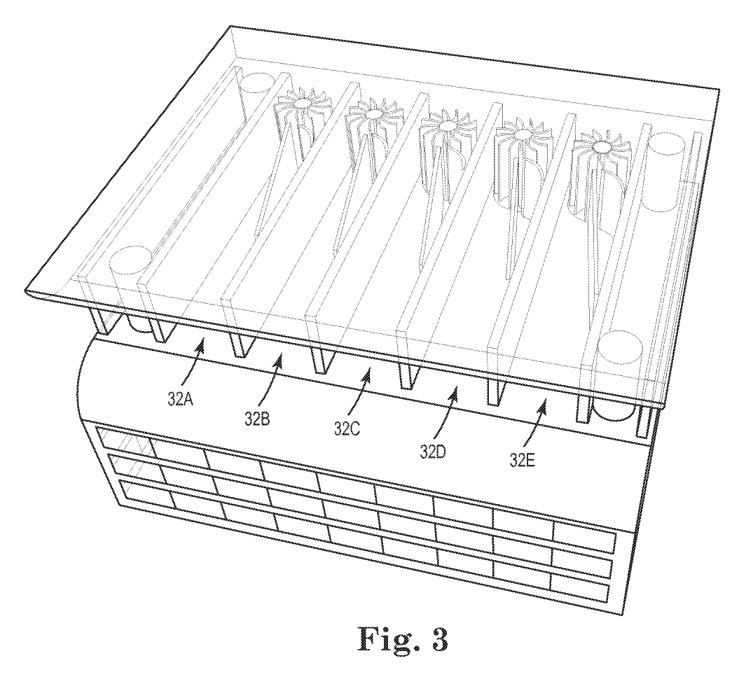

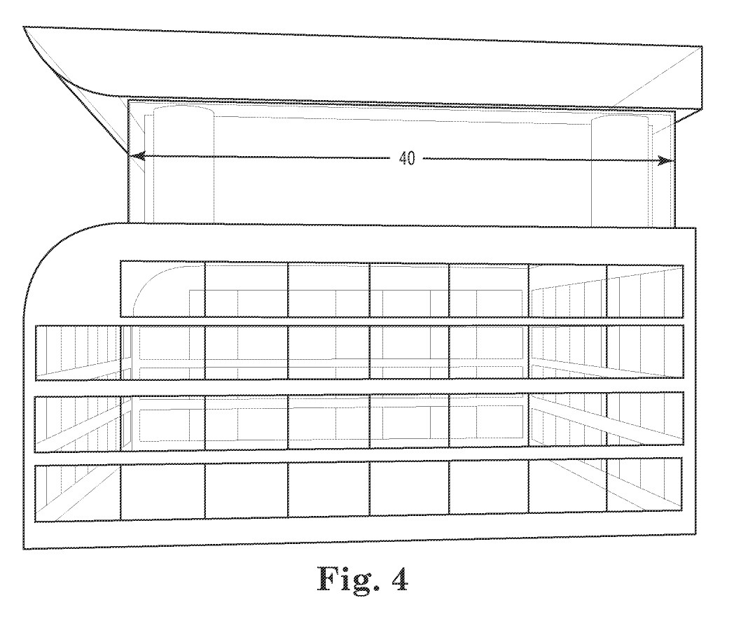

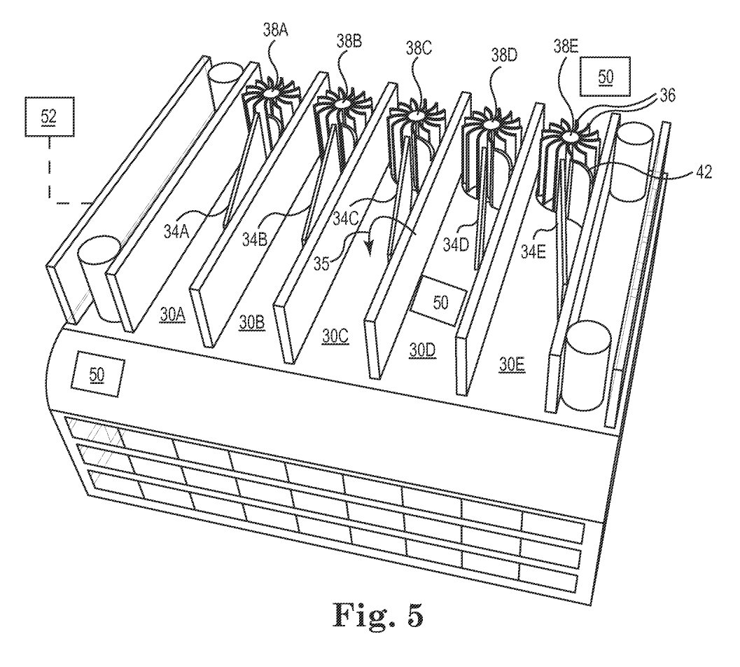

FIGS. 1 through 5 illustrate a roof-mounted integrated wind energy harvesting system 20 integrated with building 22 in accordance with an embodiment of the present invention. Roof 24 of the building 22, APCC walls 26 and roof 28 over the system 20 define a plurality of APCCs 30A, 30B, 30C, 30D, 30E (“30”) each with a discrete air intake 32A, 32B, 32C, 32D, 32E (“32”). The air intakes 32 allow utilization of wind from a wide range of directions. The system 20 may also be deployed free standing at ground level. As used herein, “structure” refers to any commercial, agricultural, residential, or industrial building. The structure preferably either supports or provides a portion of the surfaces that define part of the APCCs for a wind energy harvesting system.

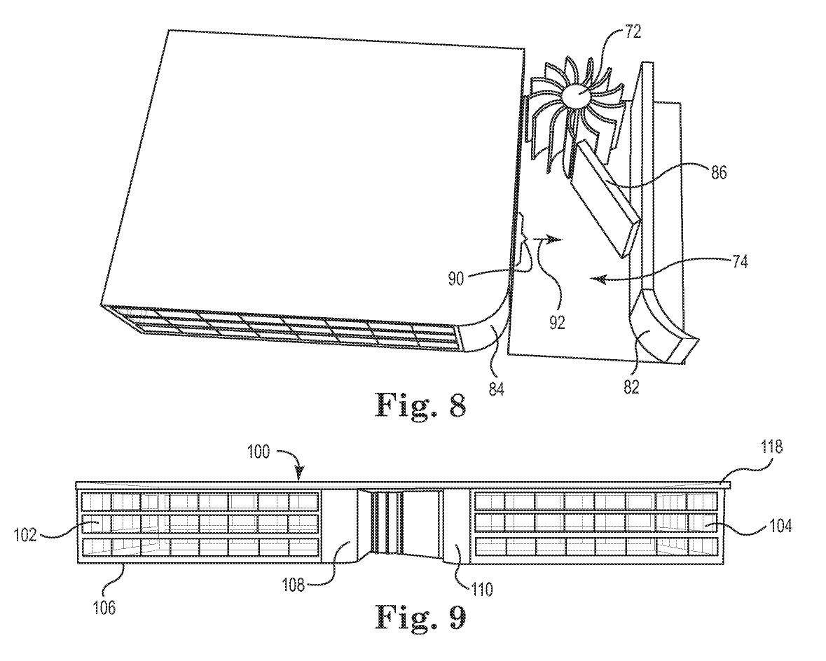

The APCCs 30 are generally partially rectangular in shape to channel the wind in near laminar flow to maximize energy harvesting. As used herein, “APCC” refers to a pressurized housing containing a fluid at a positive pressure measured relative to the ambient conditions. The APCC design is much more than just an air inlet or a simple wedge to increase wind velocities. It is volumetrically a large space that buffers wind gusts velocity swings in its accumulator space and geometry. It has walls that can be shaped dynamically to optimize wind flow into the turbine and thereby produce significant increases in electrical power over a very wide range of ambient weather conditions (see e.g., FIG. 8).

Flow control structures 34A, 34B, 34C, 34D, 34E (“34”) direct the wind energy to blades 36 of the turbines 38. Flow control structure refers to one or more louvers, vanes, baffles, air foils, bladders and other surfaces or structures configured to control and direct airflow through APCCs. Length 40 of the APCCs 30 helps provide the buffer accumulator volume of the APCC that is needed to develop smooth, high kinetic energy laminar flow, properly aligned to the turbine 38. Deflectors 42 prevent wind from impacting returning backs of blade sets 36, thereby significantly improving energy harvesting efficiency.

Each turbine 38 converts mechanical energy from the rotation of the blades 36 into electrical energy. Generally speaking, the turbines 38 include an electrical generator, e.g., alternator, and associated electronics to conform the generated electricity within prescribed parameters. Various generator configurations known in the art can be used, such as those available from Siemens, GE Energy, Reprocess Systems AG, Sinovel, Southwest Windpower Inc., of Flagstaff, Ariz. and others. Selection of a particular generator configuration can be based upon a number of factors and trade-offs, such as cost, efficiency, prevailing wind parameters, electrical power requirements, and size.

For example, in the exemplary embodiment, the generator set can include a three-phase brushless permanent magnet alternator, along with associated electronics to rectify the power to direct current and a voltage regulator to keep voltage from rising over a set point. The electrical flow from numerous individual wind turbines 38 can be accumulated by connection to a busway that includes embedded electronics to restrict the flow of electricity in one direction. An electrical junction box can be positioned at the end of the busway to receive this electricity and direct it, as needed, such as to another electrical infrastructure for within building use, utility power line and grid electrical supply, an electrical storage device (battery) or to other applications within the structure 22.

The vertical axis of rotation for the turbine blades 36 maximizes vertical and horizontal compactness. The design of turbine blade 38 is quieter than propeller driven wind turbine devices. In one embodiment, each set of turbine blades 36 includes a separate electric generator. In another embodiment, a single generator is powered by some or all of the turbines 38.

There are other designs of turbine blades suitable for the present application, including flat paddle arrays, auger turbines, aerodynamic foil segments, cup arrays, segmented and clocked cups or buckets, screw-like sections, and various other configurations. Such alternate turbine blade designs are available from Regenedyne of Sierra Veta, Ariz. and their Maglev approach, Regenerable Power Tech of Las Vegas, Nev. and theirNatura-Levo designs, Helix Wind of San Diego, Calif. and their Helix approach. Other custom approaches include VAHKT, Savinous (S-type) and the like. The conversion of wind into rotational energy and then into electricity is well understood once the wind energy has been converted into shaft rotational energy, such as disclosed in U.S. Pat. Nos. 7,215,039; 7,215,037; 6,981,839; 6,765,309; 6,674,181; 6,041,596; 5,447,412; 5,394,016; 5,332,354; 5,272,378; 4,278,896; 1,345,022, which are hereby incorporated by reference.

The flow control structures 34 are preferably dynamically configurable to fine tune kinetic energy delivered to the turbines 38 in varying wind conditions. In one embodiment, the flow control structures 34 pivots along arc 35 around vertical axes 44 located near the air intakes 32 to reduce the cross-sectional area of the APCC 30. Alternatively, the flow control structures 34 pivot anywhere along their lengths, and rely on the deflectors 42 to prevent wind from impacting the backs of the blades 36. In another embodiment, the flow control structure 34 can be rotated and/or translation anywhere within the APCC 30.

The present dynamic flow control system permits adjustment of the flow control structure 34 to compensate for fluctuations in wind direction and speed to optimize power generation. The flow control structure 34 can be dynamically configured to increase or decrease wind velocity at the turbines 38 as needed. Each flow control structure 34 is preferably independently controlled. For example, flow control structure 34A can be configured to completely close the air intake 32A to permit maintenance on turbine 38A. Alternatively, one or more of the flow control structures 34 can be partially or fully closed to reduce electricity generation during periods of reduced demand.

A network of sensors 50 is located on or near the structure 22, and in and around the APCCs 30, to measure air flow characteristics and turbine operation characteristics. The air flow characteristics, including without limitation, ambient wind velocity, ambient wind direction, ambient wind gust levels, ambient barometric pressure, ambient relative humidity, weather service severe weather alerts, APCC wind velocities at turbine face and near mouth of inlet, APCC gust levels, APCC pressures at turbine face and near mouth of inlet, pressure on turbine backside, noise downstream from the APCC outlet, and APCC relative humidity. The turbine operation characteristics, including without limitation, turbine speed (rpm), position of louvers, vanes, excess air exhaust doors and APCC wall, generator output, building electrical power consumption from turbine(s) and separately from the utility, generator output going back into the electrical utility grid and turbine axial force variations and levels that would be likely associated with turbine imbalance or bearing issues.

The output of these sensors 50 is processed by computer 52 to determine the optimum configuration of the flow control structures 34 to maximize power generation. The computer 52 can be a special use computer or a general computer, such as a PC. Consequently, the present dynamic flow control system provides a closed-loop control system that maximizes power generation and assists in system maintenance.

The computer 52 can be located at the structure 22 or remote there from. The computer 52 activates drive mechanisms that modify the configuration of the flow control structures 34 to achieve the optimum wind flow and direction through the APCCs 30 for electricity generation. Consequently, the present system 20 is adapted to generate commercial levels of electrical power over a much wider range of prevailing wind velocities and masses, and at locations where conventional wind turbines cannot be practically located.

The present system 20 can be integrated into existing structures that were not previously designed to generate electricity from the wind. As a result, virtually any building can be retrofit to generate electricity at a reasonable cost and without extensive modifications to the structure. The present system 20 can also be easily incorporated into new building designs or added to existing building without significantly altering the aesthetics of the building. The present invention makes wind-power a viable addition to some residential and most commercial buildings.

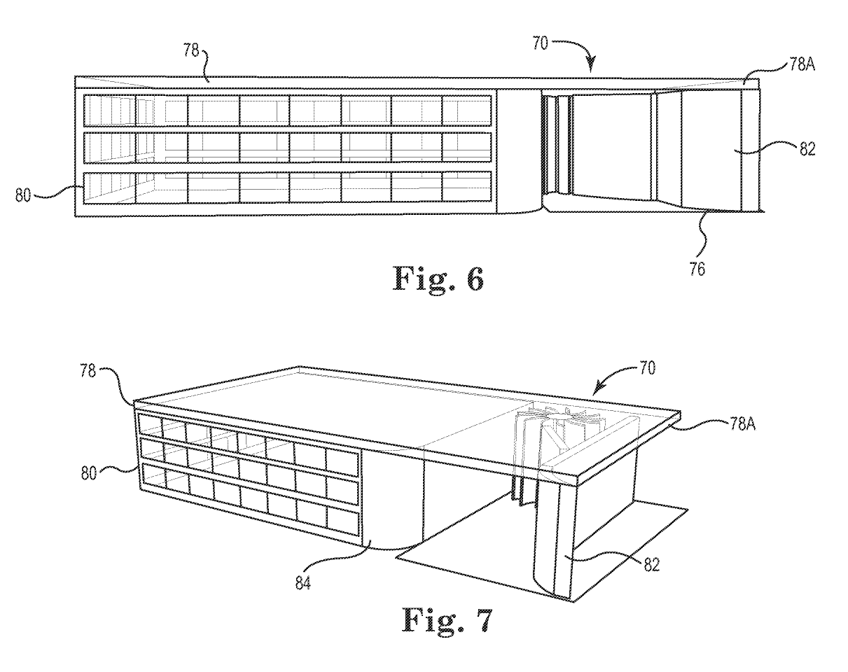

FIGS. 6 through 8 illustrate a side-mounted free-standing or building partially integrated wind energy harvesting system 70 in accordance with an embodiment of the present invention. Turbine 72 is located in proximity to APCC 74 at or near ground level 76. Roof 78 of structure 80 extends to APCC wall 82, while the structure 80 provides the opposite APCC wall 84. The turbine height and diameter is preferably sized to take full advantage of the structure's height, thereby maximizing energy output. Flow control structure 86 is located in APCC 74. The embodiment of FIGS. 6-8 is easily added onto an existing structure 80, by simply adding APCC wall 82 and adding extended the roof structure 78A.

FIG. 8 illustrates an alternate flow control structure 90 engaged with APCC wall 84. The flow control structure 90 can be retracted flush with APCC wall 84 or extended in direction 92. The flow control structure 90 can be an inflatable bladder, one or more rigid elements hinged or slidably engaged with the APCC wall 84, or a variety of other structure.

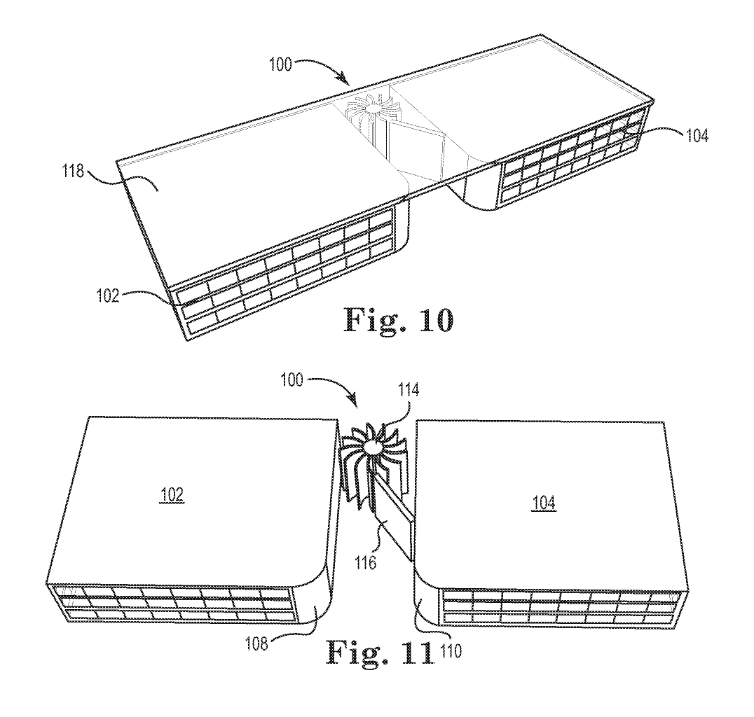

FIGS. 9 through 11 illustrate either a free-standing or partially building integrated wind energy harvesting system 100 located between two structures 102, 104, in accordance with an embodiment of the present invention. The split or dual building approach uses the ground 106 and opposite walls 108, 110 of the buildings to create three sides of APCC 112 with the roof 118 creating the fourth side. While FIG. 9 illustrates a single turbine 114 with a single flow control structure 116, multiple turbines can be incorporated in proximity to the APCC 112.

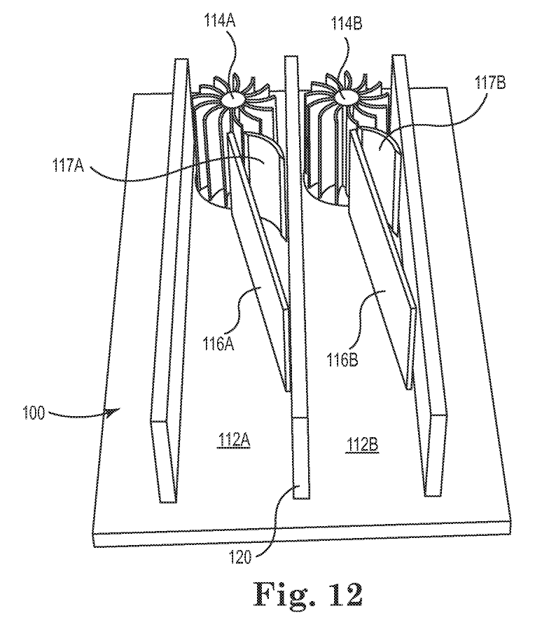

FIG. 12 illustrates a multi-turbine embodiment of the free standing or partially building integrated wind energy harvesting system 100. Dividing wall 120 separates APCC 112 into two APCCs 112A, 112B. The APCCs 112A, 112B can be the same or difference sizes. Similarly, the turbines 114A, 114B can be the same or different in dimensions, geometric shape and configuration. In one embodiment, one of the flow control structure 116A, 116B is substantially closed during low electricity demand periods. The baffles 117A, 117B are designed to prevent incoming air from impinging upon the turbine blades' backsides and adversely affecting electrical output.

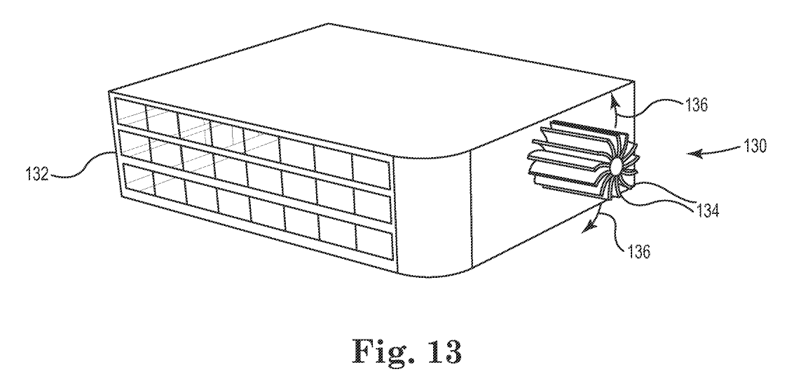

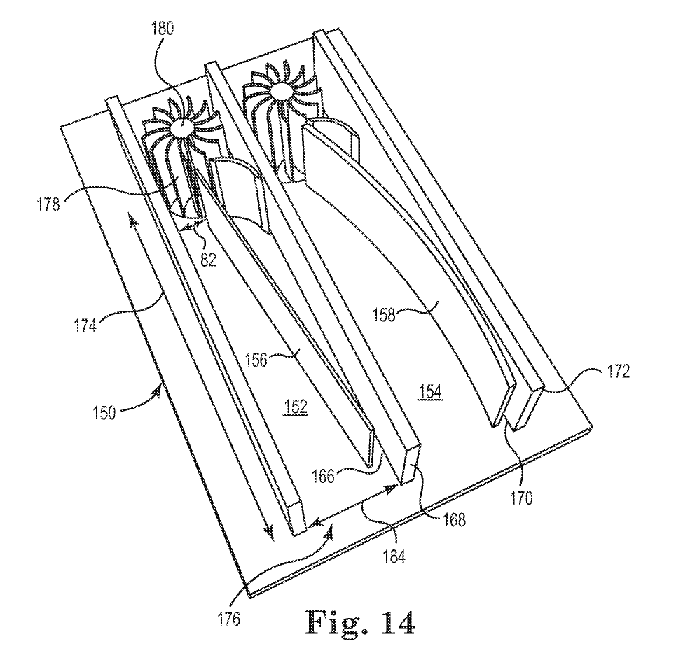

FIG. 13 illustrates an alternate wind energy harvesting system 130 partially integrated with building 132 in accordance with an embodiment of the present invention. The roof and outer APCC vanes, baffles and walls have been removed for viewing. The turbine blades 134 are configured generally horizontally, although the turbine and blades 134 can optionally pivot up and down along arcs 136.

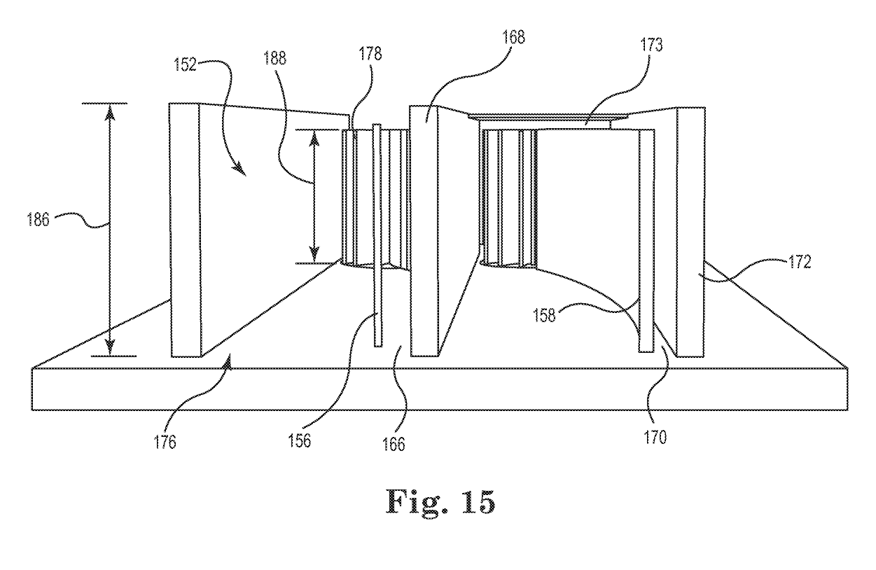

FIGS. 14 and 15 illustrate an alternate wind energy harvesting system 150 in accordance with an embodiment of the present invention. The roof is removed to expose the components located within APCCs 152, 154.

Flow control structure 156 in APCC 152 is generally a vertical flat surface. In this case, the flow control structure 156 is a rigid surface that is angled or pivoted mechanically to change the taper down the length of the APCC 152 and/or the width of the APCC 152 immediately prior to turbine 160. By altering the shape of the APCC 152, the flow dynamics in the turbine 160 can be optimized based on the external wind conditions at each moment, thereby generating the maximum power possible from prevailing winds of the time or a lesser amount that fits a building usage or power utility based need.

Flow control structure 158 in APCC 154 is curvilinear. The curvilinear shape of the flow control structure 158 is preferably dynamically adjustable, such as with a plurality of actuators (pneumatic, mechanical or hydraulic). The flow control structure 158 can be constructed from a variety of flexible materials, such a heavy duty rubber or light gauge spring steel sheets. In another embodiment, the flow control structure 158 is mechanically segmented. In another embodiment, the flow control structure 158 is a bladder or set of bladders that can be pressurized to varying levels to produce optimum APCC shapes.

Bypass 166 is optionally created between flow control structure 152 and APCC wall 168. Similarly, bypass 170 is optionally created between flow control structure 158 and APCC wall 172. The bypasses 166, 170 are used to tune air flow through the APCCs 152, 154, especially in strong wind velocity conditions. Other such bypass designs could be incorporated into other areas of the APCC region. Louvers or vanes are preferably included and dedicated to regulate the air flow through the bypasses 166, 170. A ductwork approach would likely be used to keep the excess air flow from influencing the APCC interior space and from impacting the turbine blades. One such location is shown as feature 173 (where the louvers and the bypass bottom floor have been removed for viewing of the passageway.

By way of example only, for winds with mean velocities of between about 3 miles per hour (“mph”) to about 70 mph, a highly desirable working range, distance 174 from the air intake 176 of the APCC 152 to an exposed face 178 of turbine 180 is preferably between about 1 to about 20 times width 182 of the exposed face 178. The exposed face 178 is the portion of the turbine that is acted upon by air flowing through the APCC 152.

For a vertical axis turbine, width 184 of the APCC 152 is preferably between about 1 to about 15 times the width 182 of the turbine exposed face 178. As best illustrated in FIG. 15, height 186 of the APCC 152 at the air intake 176 is preferably between about 1 to about 5 times height 188 of the turbine exposed face 178. Total volume of the APCC 152 therefore is preferably between about 200 to about 300,000 cubic feet for an exposed face 178 of about 10 feet tall and about 2 feet wide. The time for the air to be contained in the APCC 152 is typically between about 1 to about 3 seconds.

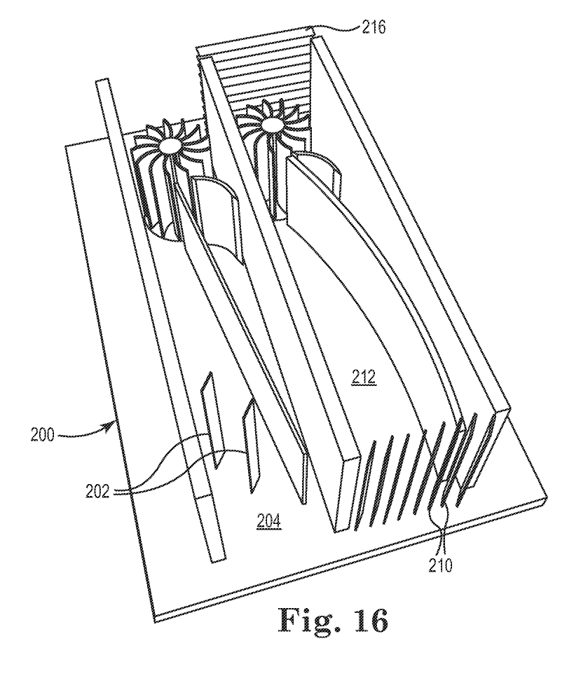

FIG. 16 illustrates a wind energy harvesting system 200 with additional flow control features in accordance with an embodiment of the present invention. Vanes 202 direct airflow through APCC 204. The vanes 202 preferably articulate dynamically to optimize the airflow for the prevailing wind conditions, as part of a dynamic flow control system discussed above. The height, location and number of vanes 202 may vary. For example, the vanes 202 may cantilever out from any of the inner surfaces of the APCC 204. The position of flow control structure 206 is also preferably dynamically controlled.

Louvers 210 are optionally located at the entrance to APCC 212. The louvers 210 are preferably dynamically controlled by the dynamic flow control system discussed above. The position and configuration of the louvers 210 can be used to regulate air flow and to protect the turbine 214 during severe weather. The louvers 210 can also be used to steer off-angle wind into the APCC 212.

Louvers 216 are optionally located at the outlet of APCC 212. The louvers 216 can be used to direct the exiting wind velocity and sound in desired directions, as well as to help modulate turbine backpressure to help optimize the air flow through the turbine blades. The louvers 210, 216 are particularly useful to protect the turbines 214 from ice build-up during ice storms. After the weather improves, the louvers 210, 216 are opened so that power generation can start immediately. This is a radical improvement over current commercial wind turbine farms where ice can shut down operations for days waiting for the ice to thaw and fall off the blades.

Where a range of values is provided, it is understood that each intervening value, to the tenth of the unit of the lower limit unless the context clearly dictates otherwise, between the upper and lower limit of that range and any other stated or intervening value in that stated range is encompassed within the inventions. The upper and lower limits of these smaller ranges which may independently be included in the smaller ranges is also encompassed within the inventions, subject to any specifically excluded limit in the stated range. Where the stated range includes one or both of the limits, ranges excluding either both of those included limits are also included in the inventions.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A system for generating electricity from wind, the system comprising:
a free-standing structure or some level of integrated building structure comprising at least one APCC having an air intake and an air outlet;
at least one turbine located in proximity to the APCC, the turbine adapted to convert mechanical energy from the rotation of blades under force of the wind into electrical energy;
at least one dynamically configurable flow control structure located in the APCC between the air intake and the turbine; and
a dynamic flow control system adapted to configure the flow control structure in response to air flow conditions to optimize the generation of electric energy.

2. The system of claim 1 comprising actuators to displace the flow control structure in at least one of rotation or translation.

3. The system of claim 1 comprising at least one dynamically configurable bypass adapted to control velocity and volume of wind directed to the turbine.

4. The system of claim 1 comprising at least one deflector baffle that prevents wind from impacting back sides of blades.

5. The system of claim 1 wherein a shape of the flow control structure is dynamically configurable into curvilinear geometries.

6. The system of claim 1 comprising dynamically configurable louvers located near the air intake of the APCC.

7. The system of claim 6 wherein the louvers are adapted to operate through a range of alignments from minimal impact upon prevailing winds, through various levels of prevailing wind steering all the way to substantially blocking wind flow, rain, ice and snow from entering the APCC and turbine sections.

8. The system of claim 1 comprising dynamically configurable louvers located near the air outlet of the APCC.

9. The system of claim 8 wherein the louvers are adapted to control back pressure on the blades.

10. The system of claim 8 wherein the louvers are adapted to direct airflow and noise leaving the air outlet.

11. The system of claim 1 comprising a plurality of sensors locating in and around the structure that measure air characteristics of the wind and environmental factors.

12. The system of claim 1 comprising a plurality of sensors locating in and around the APCC that measure air flow characteristics within the system.

13. The system of claim 1 comprising a computer controlling the air flow structures in response to air flow characteristics and turbine operation characteristics to maximize electric energy generation.

14. The system of claim 1 wherein a distance from the air intake to an exposed face of the turbine is between about 1 times to about 20 times a width of the exposed face of the turbine.

15. The system of claim 1 wherein a width of the air intake is between about 1 times to about 15 times a width of an exposed face of the turbine.

16. The system of claim 1 wherein a height of the APCC is between about 1 times to about 5 times a height of an exposed face of the turbine.

17. The system of claim 1 wherein a dwell time of air in the APCC is between about 1 second to about 3 seconds.

18. A free-standing or partially integrated building structure comprising:
at least one APCC having an air intake and an air outlet;
at least one turbine located in proximity to the APCC, the turbine adapted to convert mechanical energy from the rotation of blades under force of wind into electrical energy;
at least one dynamically configurable flow control structure located in the APCC between the air intake and the turbine; and
a dynamic flow control system adapted to configure the flow control structure in response to air flow conditions to optimize the generation of electric energy.

19. A dynamic flow control system for generating electricity from wind, the system comprising:
a free-standing or partially integrated building structure comprising at least one APCC, each with at least one air intake and air outlet;
at least one turbine located in proximity to the APCC region, the turbine adapted to convert mechanical energy from the rotation of blades under force of the wind into electrical energy;
at least one dynamically configurable flow control structure located in the APCC between the air intake and the turbine;
a plurality of sensors locating in and around the structure that measure air flow characteristics of the wind and turbine operation characteristics; and
a computer adapted to control the air flow structures in response to air flow characteristics of the wind and turbine operation characteristics provided by the sensors to optimize electric energy generated.

20. The system of claim 19 comprising a plurality of sensors locating in and around the APCC that measure air flow characteristics of the wind within the APCC for system control and optimization of electric energy generation.

21. The system of claim 19 comprising controlling one or more vanes within the APCC chamber which can be dynamically controlled to fine tune wind velocity into the turbine.

22. The system of claim 19 wherein the step of controlling an air flow structure at least partially comprises inflating a bladder to change the cross-sectional shape of the APCC.
